(19) United States
(12) Patent Application Publication
(10) Pub. No.: US 2025/0078109 A1
(43) Pub. Date: Mar. 6, 2025

(54) CUSTOMER LOYALTY REWARDS METHOD

(71) Applicant: VERDE GLOBAL SDN BHD, Kuala Lumpur (MY)

(72) Inventors: Kenneth Gerard PEREIRA, Kuala Lumpur (MY); Wai Peng LAI, Kuala Lumpur (MY)

(21) Appl. No.: 18/559,966

(22) PCT Filed: May 11, 2022
(86) PCT No.: PCT/MY2022/050036

§ 371 Date: Nov. 9, 2023

(30) Foreign Application Priority Data
May 12, 2021 (MY) PI2021002654

(51) Int. Cl. G06Q 30/0214; G06Q 30/0207

(52) U.S. Cl. CPC G06Q 30/0214; G06Q 30/0216

(57) ABSTRACT

A method that mobilizes mass collective action; utilizes current technology; leverages on digital and print media marketing channels; optimizes the utility of Rewards Programs; uses a restricted investment mandate; and uses the attractive feature that the method in itself multiplies the value initially obtained through participation in Rewards Programs, towards the achievement of the goals of a Climate Agreement or a general improvement of the environment. The greatest impediment to the achievement of the abovementioned goals is the securing of the necessary capital that will catalyze the delivery of the objectives. The method enables the funding that is necessary to be secured, painlessly and urgently. The democratization of the financial responsibility towards the achievement of an improvement to the environment using the disclosed mechanism also results in an outcome that financial returns are also a shared benefit.

### FIELD OF THE INVENTION

The present invention relates generally to Rewards Programmes which are used to incentivize customers of a product or service to become repeat purchasers and users of that product or service. More particularly, the present invention relates to a new kind of Rewards Programme, which allows for the traditionally structured rewards earned by customers of a product or service to be monetized into useable monetary funds which are invested exclusively into projects which pursue the goals of climate agreements such as the Paris Climate Agreement or a general improvement of the environment, with these selected projects delivering a safe but modest financial return. The financial returns from the investments are periodically distributed back to the individual members of the Rewards Programme. The financial gains may also be reinvested into further projects as a means of generating even further, compounded returns.

### BACKGROUND OF THE INVENTION

In recent years, it has become increasingly popular to purchase many varieties of products and services over the internet. Online sales are exponentially gaining in utility and this increasingly popular trend is creating a marketplace, traditionally occupied with businesses modelled on brick and mortar-based enterprises, that is immensely competitive. Amidst fierce competition, businesses are using a variety of marketing tools to attract and acquire new customers whilst simultaneously, deploying customer retention strategies to ensure that those who have been secured, are not lost. In such a competitive environment, Rewards Programmes have become increasingly popular.

Many models of Rewards Programmes are available. Prominent examples are Cash Rebates, Air Miles and Points Programmes. Mileage related programmes are generally offered by airlines. Customers who register for this type of programme earn mileage credits for actual air mileage flown. Branding is a critical element of this customer retention strategy and programmes such as Krisflyer, Mileage Plus and Skywards are all globally recognized names in the arena of air-mileage based Rewards Programmes.

Points programmes are similarly very popular with Credit Card providers. At a fundamental level, Credit Card users are credited with a certain number of virtual points for each dollar spent through the utilization of a specific Credit Card. These virtual points may then be exchanged for certain products or services by applying specified formulae.

Cash rebates are also a form of Rewards Programmes. In this case, actual cash accumulates as a form of reward for the purchase of products or services and this cash may be used as a credit to offset against future purchases, generally for a similar product or service.

More recent innovations in this area have included rewards in the form of equity. In such a case, purchase of a product or service gives the customer the reward of gradually accumulating equity, normally in fractional steps, in the organization from which the products or services are sourced.

It has also been discovered that some organizations have adopted an environmental agenda, by way of extending their internal corporate social responsibility agenda to include the participation of their customer base in a hybrid form of a Rewards Programme. An example of this type of Rewards Programme would see the organization contributing in the area of for example, the environment, where planting of trees as a means of carbon dioxide sequestration. In this rewards model, the more a customer uses a product or service of a particular organization, then the more the contribution is towards a noble cause, as identified and supported by the organization.

However, to date none of the existing Rewards Programmes offer the significant incentive of being able to monetize points earned through the use of a product or service into specifically an environmentally beneficial investment that potentially grows financially in value over a period of time and provides long term environmentally-linked returns to the owner of the original points, i.e. this present invention is a Rewards Programme that is integrated with a Green Investment Programme that delivers tangible financial returns to the original points recipient and also contributes to an improvement of the environment.

None of the prior art researched combine the benefits of this method, which includes rewards in various forms of financial instruments with a contribution towards environmental improvement. For example, US2012/0203608A1 (Lele) describes systems and methods for providing loyalty awards, without environmental benefits and rewards only in the form of stocks. US 2003/0172015A1 (Richard John Griffin) again has no environmental benefit and actually requires a specific commitment from a customer to purchase products and/or services to be eligible for equity rewards.

### SUMMARY OF THE INVENTION

The invention is a method of mass retail funding of projects and initiatives, based on the benefits that originate from Rewards Programmes, which supports the goals of a Climate Agreement or an overall improvement to the environment whilst also delivering modest financial returns to those committing the benefits initially derived from their Rewards Programmes comprising:
an agreed business arrangement between a Business Entity (30) and a supplier (32) in which Rewards Programmes (41) granted to Customers (33) by suppliers (32) of the Customers (33) derive returns which are then redistributed to the Customers (33);
a digital application, running on a mobile device and/or computer, that allows the Customers (33) to opt for their rewards and benefits (42) to be assigned to the business entity (30) for the mandated investments (46) in projects and initiatives which support the goals of a Climate Agreement or an overall improvement to the environment;
a portal (31) or website through which the Customers (33) can sight the operational status of their investments and the returns accruing to them as a result of such investments;
a system and process to ensure that personal data of the Customers (33) as known to the suppliers (32) is kept invisible to the business entity (30) for competitive and personal data protection reasons, wherein a Unique Personal Identifier (UPI) would be assigned to each customer (33), where solely the Suppliers (32) would have full knowledge of the real identity and the corresponding UPI of each of their Customers (33); Customers (33) would have full knowledge of their individual UPI and would access the digital application using this UPI; the business entity (30) would only operate with UPIs and would not know the corresponding identity and personal data relating to Customers (33) unless Customers (33) directly register with the business entity (30);
a quantitative and qualitative relationship between the benefits or rewards secured through the purchase (40) of goods or services from the suppliers (32) by the Customers (33) and a useable common form of currency which is applied to make the investments; and
a password system to allow access and communications across the mobile and digital platforms.

While an example of a climate agreement has been provided here for illustration in the form of the Paris Climate Agreement, it is to be understood that this method applies to any form of climate agreement or any environment improvement agenda. A climate improvement agreement or environment improvement agenda can refer to an agreement or agenda, whether initiated by governmental agencies, public or private owned organizations, which relates to climate change, on climate change mitigation, adaptation and finance. The agreement is typically international. The achievement of the goals of the Paris Climate Agreement and other climate improvement agreements or other environment improvement agendas is, at this time, estimated to cost US$30-US$40 trillion, to be spent over a period of the next 30 years. At this point, the source for this magnitude of funding, to achieve such a universally beneficial and advantageous goal, is uncertain. Traditional sources of funding like the capital and debt markets will be relatively expensive thus resulting in additional costs being imposed directly or indirectly to taxpayers. Concepts like the Cross Border Adjustment Mechanism (“CBAM”) to impose tariffs on countries not investing in reducing carbon emissions will only serve to further increase the disparity and divide between countries which are wealthy and the countries which are poor.

What is required is a mechanism to secure a cheap source of funding for the activities that need to be undertaken in pursuit of the goals of the Paris Climate Agreement or any climate improvement agreement or any environment improvement agenda. Given that the main benefit that would be experienced in climate improvement would be shared positive health, it would be optimal if the financing towards the achievement of the tough goals as envisaged by the Paris Climate Agreement were a shared responsibility. It would be a further benefit if those who contribute to this shared obligation could also receive potential returns from the investments made.

In this regard, the present invention provides every segment and every individual of global society, with access to a mobile device or computer, a means to contribute towards the resolution of the affordability issues associated with the achievement of a climate agreement, such as the Paris Climate Agreement, on the basis of collective shared responsibility coupled with collective shared benefits. This method offers a new approach in the area of Rewards Programmes not previously realized.

The present invention has been developed around the belief that the benefits of traditional Rewards Programmes today are inadequate as competitive tools to retain customer loyalty. Current day customers, when selecting their choice of products or services, are complex in their decision-making processes. They also have quick access to information and are not as price sensitive as previous generations, considering also ethical and safety issues such as the use of exploited labour, the use of unsafe fertilizers or even the degree of pollution or emissions of greenhouse gases that result from the manufacture or delivery of those products or services that are being sought. Consumer preferences, evolving in complexity, require Rewards Programmes that are well developed, use available technology, while addressing the present-day needs and wants of the twenty-first century customer.

The present invention addresses some of these more complex demands of current day consumers and delivers a customer acquisition and retention programme that has many advantages.

In the first instance, it allows retail consumers to conduct their daily lives normally, purchasing their usual products and services with no practical change in behavioural patterns, accessing their preferred supplier choices and settling their payments for these products and services using payment systems that are currently available.

The present invention has a direct role to play if the supplier preferred by the retail consumer operates a Rewards Programme as a competitive tool to retain customers already acquired.

As a general rule, benefits earned through a Rewards Programmes are redeemed or exchanged in some manner for similar or alternative products or services in a one-off manner i.e., once the benefits or rewards are utilized, the value of that benefit or reward is extinguished. The one exception to this general rule is seen when Rewards Programmes exchange benefits earned for equity in the organization providing the product or service. In such Rewards Programmes, there exists a certain probability that the value of the benefit or reward may grow, particularly in the case when the organization providing the equity-based reward is public quoted.

The method is unique as it invests the monetary equivalent of the rewards or benefits acquired by the consumer, from the use of a product or service offered by a supplier that has a rewards realization relationship with a business entity (30) offering the method. Investments are only made into projects which pursue the goals of a climate agreement or an overall improvement of the environment through a reduction of greenhouse gas emissions, with these selected projects delivering a safe but modest financial return. The modest returns may be channelled back to the consumer or reinvested at the election of the said consumer.

All contributors to the method are provided with access to a Portal (31) through which a review of the status of their contributions and returns in terms of tangible monetary value may be sighted and assessed at any time. The Portal (31) will also showcase the portfolio of green project investments being undertaken by the business entity (30). This marketing of the environmental work being undertaken by each participant in the method, without a tangible change in lifestyle, delivers a positive sensation of non-tangible pride coupled with a “feel good” factor.

Multiple forms of Rewards Programmes may be integrated into this loyalty reward structure without compromising the basic principles of the method.

Individuals and corporate entities can also make direct contributions into the method as an investment into their personal or corporate sustainability agenda, whether they be Environmental, Social or Governance related.

Another embodiment of the method is as a marketing programme. Companies or organizations wishing to attract potential clients to their online or physical store can offer rewards by way of benefits or points that can be invested into the method.

The scheme can also be configured to accept philanthropic based contributions.

Access to the method is through a software-based application that is downloadable onto a mobile device or a computer.

A password system, one-time PIN, personal unique identifiers, IT hardware and blockchain based software architecture are used in combination to ensure that consumer data and personal investment records are maintained in a secure, yet accessible and redundant manner. The password system can be two-level.

In essence, the method provides ordinary individuals with an opportunity to painlessly enhance overall quality of life from an environmental standpoint through collective large-scale, mass investing in the infrastructure and technology that will in the long term improve the environment and enhance wealth. Each investment by each of the many participants of the method would be relatively small in quantum but with time and promotion of the method, there would be many small tranches being invested as Customers C₁->Cₙ (33) live their normal daily lives, making purchases from Supplier S₁->Sₙ (32) or from others working with Supplier S₁->Sₙ (32). It is to be understood that the terms “Supplier” (32) and “Customer” (33) can interchangeably refer to the singular or plural for easier understanding of explanations. It is also to be understood that “consumers” who participate are ultimately Customers (33).

### BRIEF DESCRIPTION OF THE DRAWINGS

The objects, features and advantages of the present invention will be understood from the following detailed description together with the accompanying drawings, in which:

FIG. 1 is a process diagram depicting the flow of steps among suppliers, customers, business entity and portal of the present invention in the preferred embodiment.

### DETAILED DESCRIPTION

The present invention provides a method or scheme of using the rewards granted to existing and prospective Customers (denoted C₁->Cₙ) (33) of Suppliers (denoted S₁->Sₙ) (32) such that rewards received by the Customers (33) may be converted into cash which is then invested exclusively into projects and initiatives which support the goals of a Climate Agreement such as the Paris Climate Agreement, make an overall improvement to the environment and offer a modest financial return to the investor. Financial returns from the selected projects and initiatives are channelled back to the Customers (33). Low risk investments are targeted. In this manner, rewards initially granted to consumers have a more than reasonable chance of delivering a return and growing in realizable value.

Key aspects of the present invention will now be described in detail. It is emphasized again that while an example of a climate agreement has been provided here for illustration in the form of the Paris Climate Agreement, it is to be understood that this method can be applied to any climate agreement or any environmental improvement agreement.

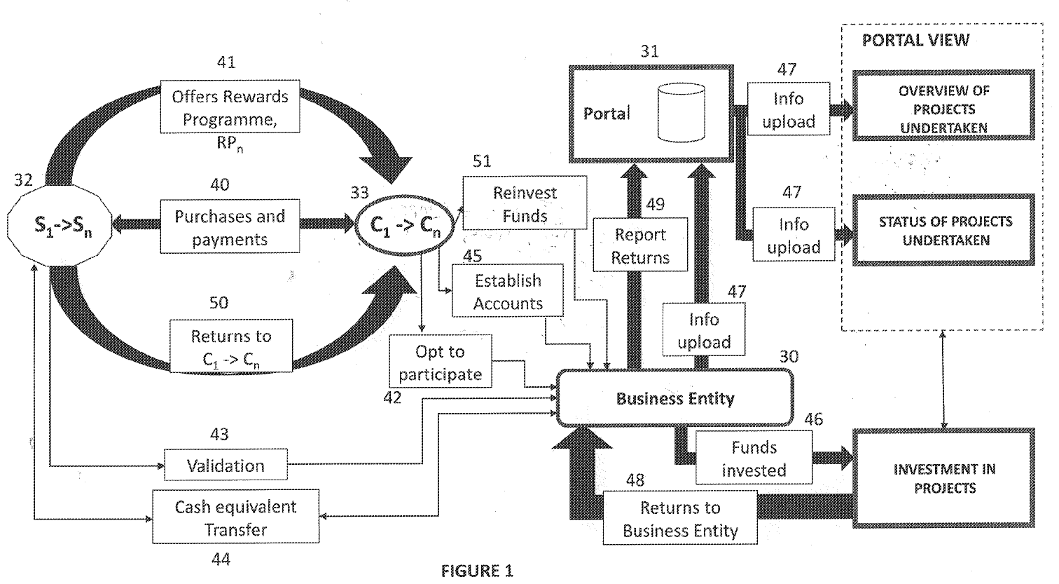

The present invention operates as a series of steps within a process. The method comprises the integration of all elements, features and characteristics of the scheme into a functional package. As per FIG. 1, one, or up to all of Suppliers S₁->Sₙ (32), are suppliers of goods or services to Customers, C₁-Cₙ (33). Suppliers S₁->Sₙ (32) have agreements with a business entity (30) to be participants of the scheme. Customers (33), are members of Rewards Programmes (RP₁-RPₙ) which are part of the scheme offered by Suppliers (32) as options under the Rewards Programmes. Customers (33) may also directly be members of the scheme.

Customers (33) conduct their business, without any requirement for a change in behaviour, purchasing products and services (40) from their Suppliers (32).

Suppliers, (32), have formally linked or partnered with the business entity (30) offering the scheme.

Customers (33) are members of Rewards Programmes offered by Suppliers (32) or are directly members of the scheme.

Accordingly, as per FIG. 1, the steps of the process are as follows:

Customers (33), make purchases of goods and/or services (40) from Suppliers (32), and settle payment (40) for such delivered goods and/or services as per their agreed payment terms. Suppliers (32) offer Rewards Programmes (41) and Customers (33) accrue benefits which can be in the form of air miles, virtual points, cash rebates, equity rewards or general loyalty benefits. Customers (33) opt to participate (42) in the method offered by the business entity (30) and assign the benefits to the business entity (30). Customers (33) are assigned a Unique Personal Identifier (UPI) which masks the identity of the Customers (33) from the Business Entity (30) supporting the scheme thus ensuring that customer behavioural data and spending trends are retained solely with the Suppliers (32). Furthermore, only individual Suppliers (32) would have full knowledge of the real identity and the corresponding UPI of each of their Customers (33). Customers (33) would have full knowledge of their individual UPI and would access the digital application using this UPI. The business entity (30) would only operate with UPIs and would not know the corresponding identity and personal data relating to Customers (33) unless the Customers (33) directly register with the business entity (30). The business entity (30) conducts a validation (43) with the Suppliers (32) to confirm whether the Customers (33) actually own the benefits (23). If the benefits are owned by the Customers (33), then the Suppliers (32) transfers to the business entity (30) a cash amount equivalent (44) to the value of the accrued benefits. The cash amounts may be delivered to the business entity (30) in certain currencies with these amounts being converted to the working currencies of the scheme which can be United States Dollars (“USD”) or accepted or proprietary digital currencies, using valid exchange rates at the time of conversion. Note: The beneficial owners of the benefits, in whichever form, remain the Customers (33). The business entity (30) establishes accounts (45) for the Customers (33). These accounts may be identified through unique identifiers originated by the Suppliers (32) or these accounts may be identified through the actual personal data of the Customers (33), depending on the business policies of the Suppliers (32), the business entity (30) and applicable personal data protection laws. The Customers (33) are able to sight information relating to the current value of their benefits/investments by accessing their accounts which are maintained on a secure information Portal (31) operated by the business entity (30). The funds from that have been converted from the various forms of benefits secured and owned by the Customers (33) are then invested (46) by the business entity (30) in projects that exclusively contribute to the goals of a Climate Agreement such as the Paris Climate Agreement or other environmentally friendly business opportunities that project to deliver financial returns (26). Information is uploaded (47) to the Portal (31) and subsequently to the Portal view: Overview of the projects invested by the Business Entity (30), which is open to all; and information relating to the specific investments (and their status) made by the Customers (33), only accessible to the Customers (33). The type and low business risk profile of investments made by the business entity (30) would normally generate modest returns. These returns would be channelled back (48) from the investment to the business entity (30). The returns generated from the investments are reported in the accounts of the Customers (33) which are maintained on the Portal (31), and updated on a periodic basis (29). The Customers (33) are able to withdraw their returns after they are credited to their accounts. The principal invested sum may be withdrawn at pre-defined times. The returns generated may also be channelled back (50) to the Customers (33) via their Suppliers (32) for distribution by the Suppliers (32) to the Customers (33), if that is the pre-agreed withdrawal and distribution mechanism between the business entity (30) and the Suppliers (32). The Customers (33) are also able to elect to reinvest returns (51) from investments made through participation in the scheme. This provides the Customers (33) a form of compounding of the returns from their initial Rewards Programme benefits.

It will be appreciated that with the use of software-based applications from which the consumer can access the services and features such as the Portal (31) by the use of mobile devices or computers, that the system required would typically need to be equipped with computer servers and communication means such as Internet access equipment. The servers would have components such as processors, data storage devices and memory. Internet access equipment would include modems and routers as required.

1. A method of mass retail funding of projects and initiatives, based on the benefits that originate from Rewards Programmes, which supports the goals of a Climate Agreement or an overall improvement to the environment whilst also delivering modest financial returns to those committing the benefits initially derived from their Rewards Programmes, comprising:
an agreed business arrangement between a Business Entity and a supplier in which Rewards Programmes granted to Customers by suppliers of the Customers derive returns which are then redistributed to the Customers;
a digital application, running on a mobile device and/or computer, that allows the Customers to opt for their rewards and benefits to be assigned to the business entity for the mandated investments in projects and initiatives which support the goals of a Climate Agreement or an overall improvement to the environment;
a portal or website through which the Customers can sight the operational status of their investments and the returns accruing to them as a result of such investments;
a system and process to ensure that personal data of the Customers as known to the suppliers is kept invisible to the business entity for competitive and personal data protection reasons, wherein a Unique Personal Identifier would be assigned to each Customer, where solely the Suppliers would have full knowledge of the real identity and the corresponding UPI of each of their Customers; Customers would have full knowledge of their individual UPI and would access the digital application using this UPI; the business entity would only operate with UPIs and would not know the corresponding identity and personal data relating to Customers unless Customers directly register with the business entity;
a quantitative and qualitative relationship between the benefits or rewards secured through the purchase of goods or services from the suppliers by the Customers and a useable common form of currency which is applied to make the investments; and
a password system to allow access and communications across the mobile and digital platforms.

2. The method of claim 1, further comprising:
a programme of advertising that includes the use of digital advertising and social media; and
a programme of promotion that uses the endorsement of prominent individuals who act as ambassadors of the noble cause of investment exclusively into projects and initiatives which support the goals of a Climate Agreement or an overall improvement to the environment.

3. The method of claim 1 wherein the rewards initially granted to the customers are in the form of air miles.

4. The method of claim 1 wherein the rewards initially granted to the customers are in the form of virtual points.

5. The method of claim 1 wherein the rewards initially granted to the customers are in the form of cash rebates.

6. The method of claim 1 wherein the rewards initially granted to the customers are in a form of equity in public or private companies linked to the suppliers.

7. The method of claim 1 wherein the rewards initially granted to the customers are in a form of Bonds or Convertible Bonds in public or private companies linked to the suppliers.

8. The method of claim 1 wherein the rewards initially granted to the customers are in a form of Warrants or Stock Options in public or private companies linked to the suppliers.

9. The method of claim 1 wherein the rewards initially granted to the customers are in a form of Preference Stock in public or private companies linked to the suppliers.

10. The method of claim 1 wherein the rewards initially granted to the customers are in a form of a crypto-currency or a part thereof.
